(19) United States
(12) Patent Application Publication
(10) Pub. No.: US 2014/0367390 A1
(43) Pub. Date: Dec. 18, 2014

(54) DEVICE FOR PREVENTING AN INCORRECT FILLING OF A TANK OF, E.G., MOTOR VEHICLES BY MEANS OF A GAS HOSE NOZZLE

(71) Applicant: REUTTER GMBH, Leutenbach (DE)

(72) Inventor: Frank Horlacher, Waiblingen (DE)

(21) Appl. No.: 14/366,783

(22) PCT Filed: Nov. 23, 2012
(86) PCT No.: PCT/EP2012/073423

§ 371 Date: Jun. 19, 2014

(30) Foreign Application Priority Data
Dec. 21, 2011 (DE) 20 2011 109 525.1
Mar. 2, 2012 (DE) 20 2012 002 220.2
Apr. 20, 2012 (DE) 20 2012 004 118.5

(51) Int. Cl. B60K 15/03

(52) U.S. Cl. CPC B60K 15/03006; B60K 2015/03019; B60K 2015/03328
USPC 220/562

(57) ABSTRACT

A device (10, 110) for preventing an incorrect filling of a tank of, e.g., motor vehicles by a gas hose nozzle (215, 315), is provided with a permanent magnet array (11, 111, 211, 311), which has a partial array (213, 313) preferably in the form of a single magnet in the discharge pipe (216, 316) of the gas hose nozzle (215, 315), and has another permanent magnet partial array (12, 112), including a plurality of permanent magnetic elements (24, 124) arranged in a ring-shaped pattern. The permanent magnets (24, 124) are held in a closed or open body (23, 123, 223), the body (23, 123, 223) has a closed or open ring-shaped design, and the north and south poles, of the permanent magnetic elements (24, 124), are aligned in the radial direction or in the direction of a longitudinal axis of the filler neck (20, 120).

### CROSS REFERENCE TO RELATED APPLICATIONS

This application is a United States National Phase Application of International Application PCT/EP2012/073423 and claims the benefit of priority under 35 U.S.C. §119 of German Utility Model Applications DE 20 2011 109 525.1 filed Dec. 21, 2011, DE 20 2012 002 220.2 filed Mar. 2, 2012 and DE 20 2012 004 118.5 filed Apr. 20, 2012, the entire contents of which are incorporated herein by reference.

### FIELD OF THE INVENTION

The present invention pertains to a means for preventing an incorrect filling of a tank of, e.g., motor vehicles by means of a gas hose nozzle provided, at a filler neck of the tank or at an insert for the filler neck or the filling opening of the tank and/or at the discharge pipe of the gas hose nozzle, with a permanent magnet array.

### BACKGROUND OF THE INVENTION

In incorrect filling systems for, e.g., motor vehicle tanks, such as urea tanks, it is known to arrange a ring-shaped permanent magnet in the filler neck and a single magnet in the discharge pipe or in the sensor line of the gas hose nozzle. This builds up a magnetic field during the inserting of the discharge pipe of the gas hose nozzle into the filler neck of the tank with the ring-shaped permanent magnet in the filler neck. The discharge pipe is thereby axially entrained and in this way releases the feed through the gas hose nozzle into the tank.

A similar system is known from DE 203 19 414 U1 as well, which discloses a system of protection against incorrect fueling. In this case, a plurality of magnetic relays are provided which are arranged at various points and form a type of coding, which open or close switching circuits upon approach of a gas hose nozzle with corresponding coding, so that an alarm is sounded in case of unsuitable coding of the gas hose nozzle. The magnets can be arranged randomly in a sector-shaped pattern with different alignment in this case.

GB 2 447 292 A discloses a system, in which a magnet is moved against a spring force and thereby moves a valve element into an opening position.

WO 2011/048016 A1 discloses various possibilities of providing magnetic elements as circular ring sections or of arranging magnetic elements in a ring-shaped pattern. In this case, the magnet is arranged exposed in a groove on the inner circumference of the neck, whereby the interruptions in case of a C-shaped magnet or an array of a plurality of magnetic segments are used to enlarge the free flow cross section.

The permanent magnets of high density that are used and are made of material combinations with rare earths, such as samarium, used are very expensive and become more expensive with increasing shortage of raw material.

### SUMMARY OF THE INVENTION

Therefore, an object of the present invention is to create a device of the type mentioned in the introduction, which uses less magnetic or magnetizable material and provides identical functional quality.

According to the invention, a device is provided for preventing an incorrect filling of a tank of motor vehicles by means of a gas hose nozzle, the device being provided at one of a filler neck of the tank or at an insert for the filler neck or the filling opening of the tank and/or at the discharge pipe of the gas hose nozzle. The device comprises a permanent magnet array comprising a partial array in the form of a single magnet in the discharge pipe of the gas hose nozzle and another permanent magnet partial array comprising a plurality of permanent magnetic elements arranged in a ring-shape and spaced apart in the filler neck or in the insert or about the discharge pipe of the gas hose nozzle. A closed or open body is also provided. The permanent magnetic elements, arranged in the ring-shape, are held in the closed or open body, wherein the body has a closed or open ring-shaped design and north and south poles of the permanent magnetic elements are aligned in a radial direction or in a direction of a longitudinal axis of the filler neck

By means of the measures according to the present invention, a reduction of the starting material weight necessary for the permanent magnets is possible, such that such permanent magnet arrays can be manufactured in a cost-effective manner. In the individual exemplary embodiments, this is achieved in such a way that either the ring-shaped magnetic array is formed by means of single magnetic elements arranged spaced apart in the form of a ring, in that only a single magnet is provided in each case, which is always in radial alignment outside the discharge pipe of the gas hose nozzle with the single magnets arranged within the discharge pipe. The distance between the individual magnetic elements selected in the first-mentioned exemplary embodiment essentially depends on the corresponding size and arrangement as well as the magnetic quality of the assigned single magnets and/or on the magnetization intensity of the single magnets of the ring array. Thus, high-performance magnets made of neodymium are advantageously used.

The permanent magnetic elements arranged in the filler neck or in the insert in the body may advantageously have a plate-shaped or cube-shaped design lying in the circumferential direction or a rod-shaped design lying in the axial or radial direction.

The permanent magnetic elements form an angle at a circumference of less than 330° or less than 300° or less than 270°.

The body may advantageously be made of plastic and the permanent magnetic elements are held in the body made of plastic.

Further details of the present invention appear from the following description, in which the present invention is described in detail and explained based on the exemplary embodiments shown in the drawings. The various features of novelty which characterize the invention are pointed out with particularity in the claims annexed to and forming a part of this disclosure. For a better understanding of the invention, its operating advantages and specific objects attained by its uses, reference is made to the accompanying drawings and descriptive matter in which preferred embodiments of the invention are illustrated.

### BRIEF DESCRIPTION OF THE DRAWINGS

In the drawings:

FIG. 1 is a schematic longitudinal sectional view of a permanent magnet array within a plastic neck according to a first exemplary embodiment of the present invention;

FIG. 2 is a sectional along the line II-II of FIG. 1;

FIG. 3 is a longitudinal sectional view similar to FIG. 1, but through a second exemplary embodiment of the present invention;

FIG. 4 is a sectional view along the line IV-IV of FIG. 3;

FIG. 5A is a longitudinal sectional view through the discharge pipe of a gas hose nozzle inserted into a neck in a starting position, whereby the view is used for better understanding and is not the subject of the present invention;

FIG. 5B is a longitudinal sectional view through the discharge pipe of a gas hose nozzle inserted into a neck in an end position, whereby the view is used for better understanding and is not the subject of the present invention;

FIG. 6A is a view corresponding to FIG. 5A, whereby the view is also used for better understanding and is not the subject of the present invention;

FIG. 6B is a view corresponding to FIG. 5B, whereby the view is also used for better understanding and is not the subject of the present invention;

FIG. 7A is an isometric view showing an embodiment with an open plastic ring, with the interior features shown in dashed line;

FIG. 7B is an isometric view showing the embodiment with the open plastic ring of FIG. 7A;

FIG. 7C is an isometric view showing the embodiment with the open plastic ring of FIG. 7A, with the interior features shown in dashed line;

FIG. 8A is an isometric view showing an embodiment with a closed plastic ring, in which the permanent magnetic elements cover an angle at circumference of less than 270°, with the interior features shown in dashed line;

FIG. 8B is an isometric view showing an embodiment with the closed plastic ring of FIG. 8A; and

FIG. 8C is an isometric view showing the embodiment with the closed plastic ring of FIG. 8A, in which the permanent magnetic elements cover an angle at circumference of less than 270°, with the interior features shown in dashed line.

### DESCRIPTION OF THE PREFERRED EMBODIMENTS

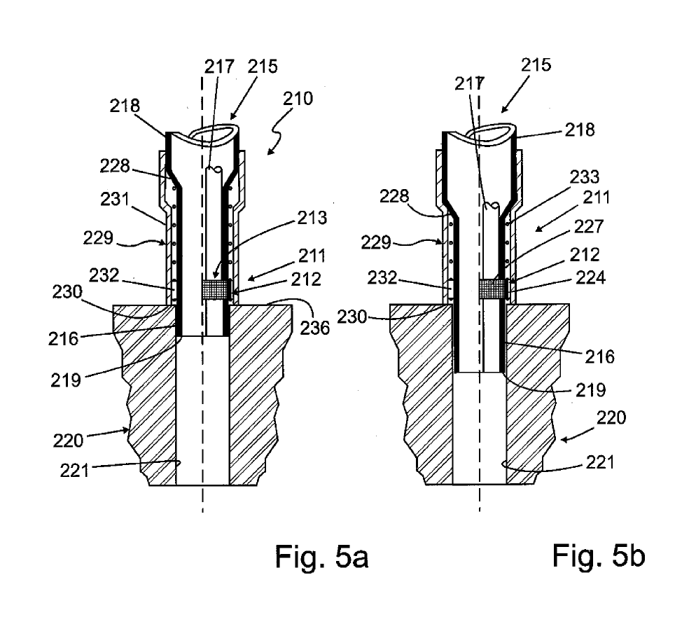

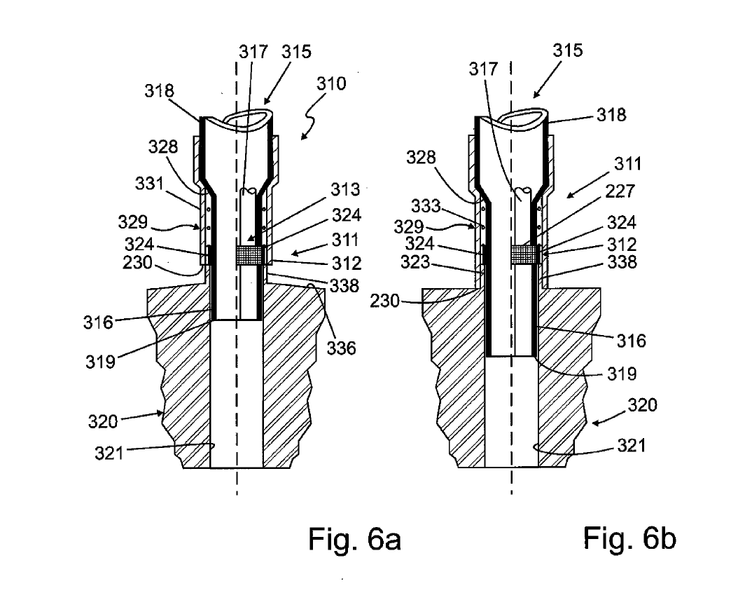

Referring to the drawings in particular, device 10, 110, 210 or 310, which are shown in the drawing according to a plurality of exemplary embodiments, are used for preventing an incorrect filling of a tank, not shown, of, for example, motor vehicles by means of a gas hose nozzle 215 or 315 shown in FIGS. 5 and 6, whereby the device 10, 110, 210 or 310 has a permanent magnet array 11, 111, 211 or 311, which consists of two partial arrays 12 and 13, 112 and 113, 212 and 213 or 312 and 313, of which the first partial array 12, 112, 212, 312 is arranged in a neck 20 made of plastic or in a plastic insert of a neck 20 of a tank, not shown, or on the outer circumference of a discharge pipe 216, 316 of the gas hose nozzle 215, 315, and of which the second partial array 13, 113, 213, 313 is held within the discharge pipe 216, 316 of the gas hose nozzle 215, 315. The two partial arrays 12, 112, 212, 312 and 13, 113, 213, 313 are coordinated to one another, such that a feed release at the gas hose nozzle 215, 315 takes place only if the two partial arrays or their magnetic fields can influence one another, which is only possible if the discharge pipe 216, 316 or the gas hose nozzle 215, 315 fits into the feed opening in the neck or of the neck insert of the tank and is pushed in up to the stop. The tanks to be filled with the device 10, 110, 210, 310 may especially be AdBlue tanks on motor vehicles, especially diesel vehicles, or may be corresponding stationary tanks on stationary drive units. It is also possible to provide the device on tanks outside motor vehicle engineering and stationary drive unit engineering.

The magnetic field alignment consisting of the partial arrays 12, 112, 212, and 312 can take place radially or axially in the plastic neck.

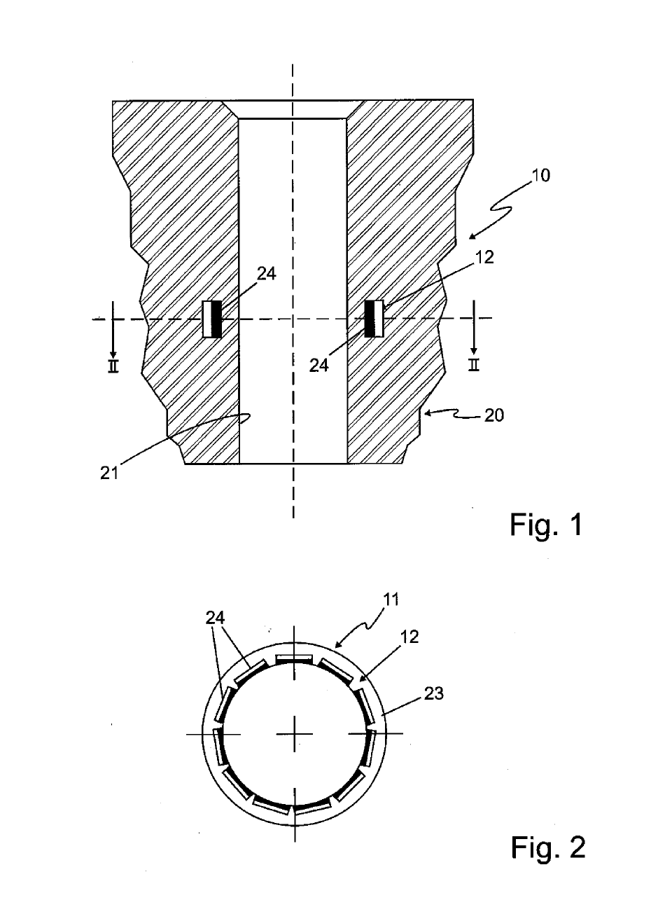

FIGS. 1 and 2 show a first exemplary embodiment of a device 10, of which only the first partial array 12 of the permanent magnet array 11 is shown. The first partial array 12 is arranged in a plastic neck 20 and is arranged in a ring-shaped pattern in the neck 20 and thus surrounding its axial hole or opening 21. As FIG. 2 shows, the ring-shaped permanent magnet partial array 12 in the neck 20 consists of a plurality of ring-shaped and plate-shaped single magnets 24 arranged spaced apart from one another, whose north-south alignment runs radially or axially, in such a way that the north pole is facing the axial opening 21. These single small magnetic plates 24 arranged in a ring-shaped pattern are held in a body 23, which can be designed as an open or closed ring, preferably made of plastic. Furthermore, the body is therefore also designated as a plastic ring. The body 23 or plastic ring 23 is cast integral in the plastic of the neck 20.

The neck 20 is connected with a tank made of plastic in a manner not shown. It is obvious that the array of single small magnetic plates 24 may also be arranged in an insert made of plastic, which insert is intended for being inserted into an opening of a neckless tank.

The second partial array, which is arranged in the discharge pipe of a gas hose nozzle in a manner not shown, consists of a single permanent magnet or is in the form of a bar magnet, as it is usually inserted, for example, in the sensor line within the discharge pipe. This permanent magnet is held in an axially movable manner within the gas hose nozzle-discharge pipe, such that it is entrained upon immersion of the discharge pipe in the neck 20 due to the magnetic action of the stationary single small magnetic plates 24 and releases the inflow of the liquid in question at the end of its axial movement by means of, e.g., a switching contact.

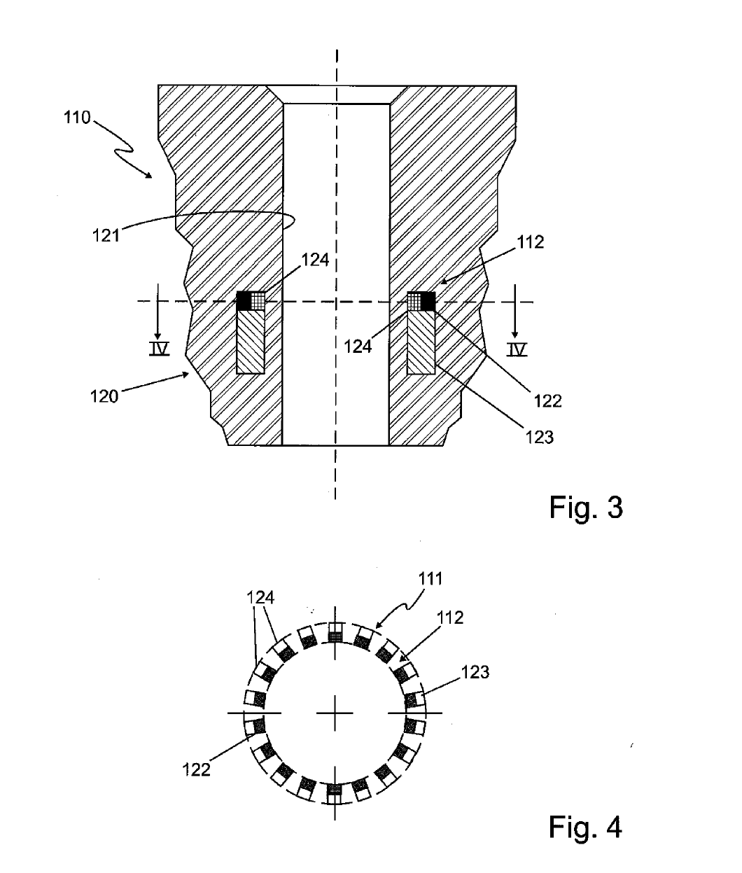

The second exemplary embodiment according to FIGS. 3 and 4 is designed similar to the first exemplary embodiment according to FIGS. 1 and 2, whereby the difference is the fact that the first partial array 112 is likewise arranged in a ring-shaped pattern in the neck 120, but consists of rod-shaped single magnets 124, which are arranged in a ring-shaped pattern and spaced apart next to one another. The north-south alignment of the single magnetic rods 124 is radial, whereby here as well the north pole is facing the axial opening 121 of the neck 120. As an alternative, an axial north-south alignment of the single magnetic rods 124 is also possible. The single magnetic rods 124 are each firmly inserted in a radially aligned hole 122 of a plastic ring 123, whereby the plastic ring 123 is extrusion-coated by the plastic of the neck 120. The radial holes 122 are provided at an axial end of the plastic ring 123.

According to an exemplary embodiment not shown, axial holes are provided in the plastic ring 123 for accommodating axially aligned single magnetic rods 124, whereby the single magnetic rods 124 are provided radially on the inside at the plastic ring 123.

The second permanent magnet partial array is provided, as described above regarding the exemplary embodiment of FIGS. 1 and 2, in an axially movable manner in the gas hose nozzle or its sensor line-discharge pipe.

In the device 210 and 310 shown in FIGS. 5 and 6, the two partial arrays 212, 213 or 312, 313 and thus the permanent magnet array 211 or 311 are all arranged outside of the neck 220 or 320 or of a tank insert and likewise in the area of the discharge pipe 216 or 316 of the gas hose nozzle 215 or 315. They show only the basic array of a permanent magnet array according to the present invention based on a (not according to the present invention) single magnet outside of the neck.

According to FIGS. 5A and 5B, the discharge pipe 216 is provided on the inside with a sensor line 217, which has a substantially smaller diameter, within which a single magnet 227 is arranged in an axially movable manner. The discharge pipe 216 passes over a conical lateral surface 228 into a gas hose nozzle pipe 218 of larger diameter. About the discharge pipe 216 and about the passage 228 to the gas hose nozzle pipe 218 is arranged a sleeve 229 which is adapted to the diameters of the discharge pipe 216, further pipe 218 and conical lateral surface 228. The sleeve 229 is shorter than the discharge pipe 216, i.e., its front surface 230 ends before the front surface 219 of the discharge pipe 216.

In the annulus 231 between the sleeve 229 and the outer circumference of the discharge pipe 216 is arranged a ring element 232, which is spring-loaded by a compression spring 233, which is supported at one end at the ring element 232 and at the other end on the conical lateral surface 228. The ring element 232 is held in a stationary manner on the inner surface of the sleeve 229, but is axially displaceable opposite the outer circumference of the discharge pipe 216.

The ring element 232 has a single small permanent magnetic plate 224 of the first partial array 212 on a peripheral area, whereby a radial or axial north-south alignment can occur and the north pole of the single small magnetic plate 224 is facing the south pole of the small magnetic plate 227 of the second partial array 213 arranged within the sensor line 217. In order to hold the two single magnets 224, 227 within the sensor line 217, on the one hand, and in the annulus 231, on the other hand, in radial alignment, the sleeve 229 is held in a nonrotatable manner at the discharge pipe 16 or at the pipe 218.

With the insertion of the discharge pipe 216 of the gas hose nozzle 215 into the axial opening of the neck 220 or of a tank insert in the direction of arrow Z, the sleeve 229 with its front surface 230 is supported on the front surface 236 of the neck. With this, as appears from the illustrated differences of FIGS. 5A and 5B, the conical lateral surface 228 of the discharge pipe 216 is shifted to the corresponding conical lateral surface 234 of the sleeve 229, whereby, with the two lateral surfaces 228, 234 being in contact with one another, the end position of the inserted discharge pipe 216 of the gas hose nozzle 215 in the neck 220 is reached. In this end position, into which the small magnetic plate 227 has moved axially in relation to the discharge pipe 216 and in which the two single permanent magnets 224, 227 lie opposite one another in the radial direction, as before, the flow in the gas hose nozzle 215 is released since the internal single magnet 227 has moved towards, e.g., a switching contact. The other view not according to the present invention according to FIGS. 6A and 6B corresponds essentially to the view of FIGS. 5A and 5B, i.e., that the ring element 332 is equipped with a partial array 312 consisting of a single small permanent magnet plate 324, whereby the single small magnetic plate 324 lies in radial alignment with the internal single small magnetic plate 327 of the second partial array 313. One difference is that the face 336 of the neck 320 is provided with an annular boss 338, which has a smaller outside diameter, which grips into the annulus 331 between the discharge pipe 316 and the sleeve 329 during the insertion of the discharge pipe 316 of the gas hose nozzle 315 into the neck 320 and pushes against the ring element 332 provided with the single small permanent magnet plate 324 and moves this element axially with magnetic entrainment of the internal single small magnetic plate 327. Here as well, the two lateral surfaces 328 and 334 are used as a stop during the insertion of the gas hose nozzle 315 or its discharge pipe 316 into the axial opening 321 of the neck 320 as an end stop. In this position according to FIG. 6B, the gas hose nozzle 315 is released for the flowing through of the liquid in question. This array is designed as tamper-proof.

The above exemplary embodiments use high-performance magnets preferably made of neodymium.

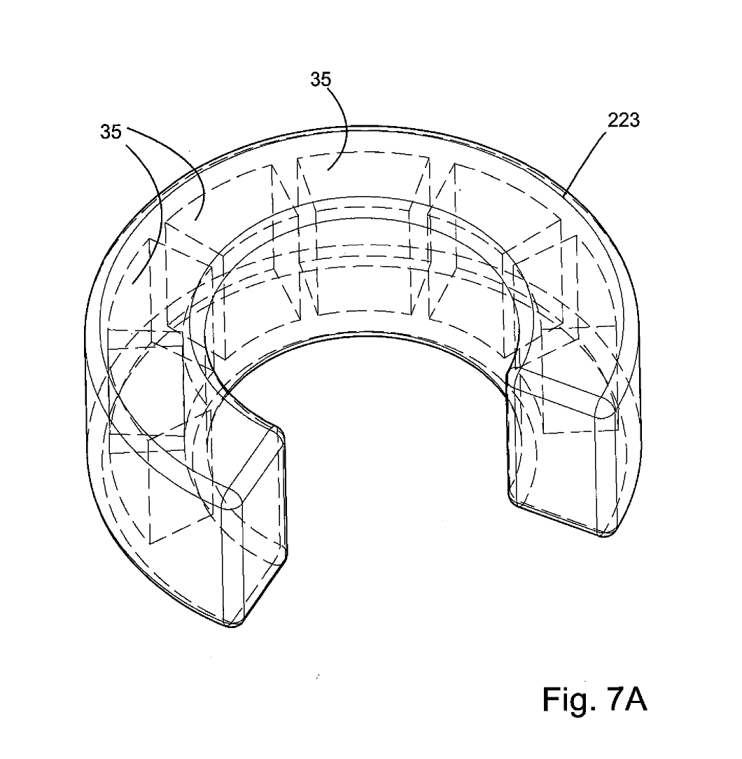

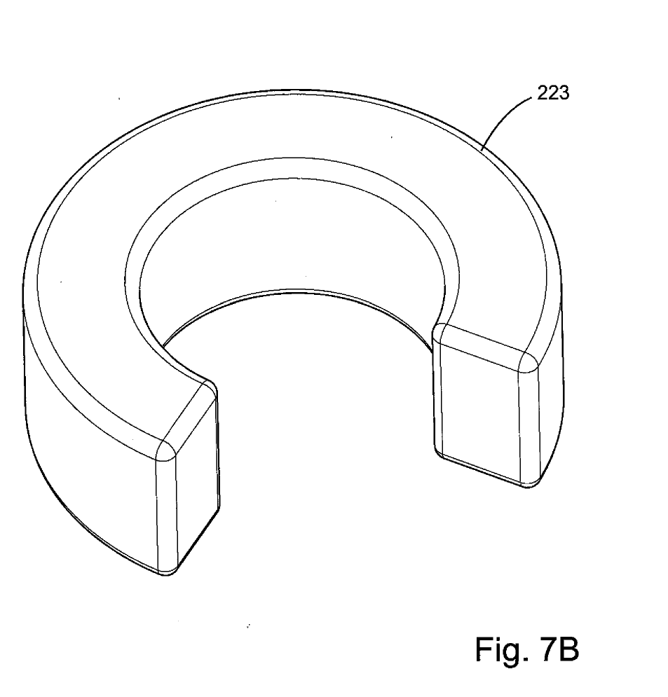

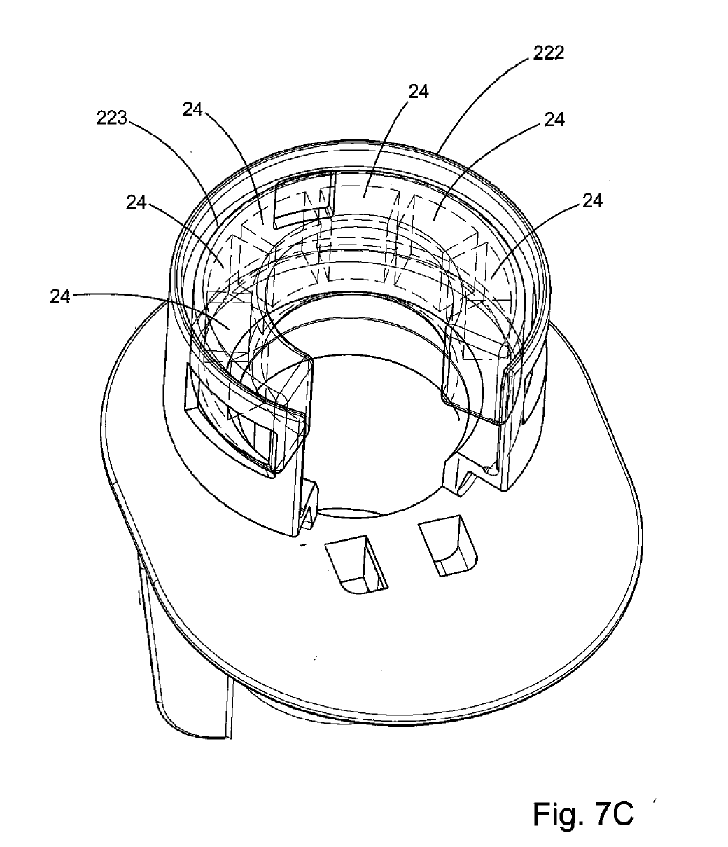

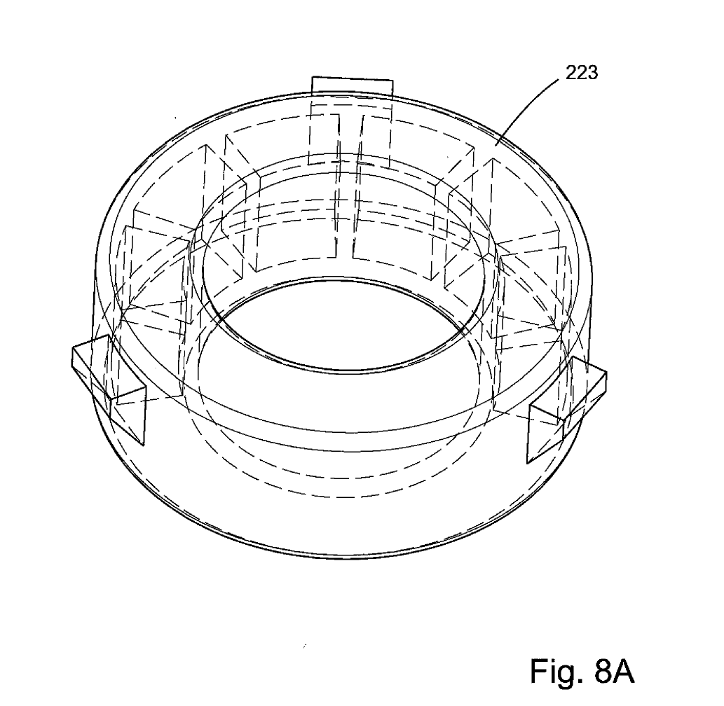

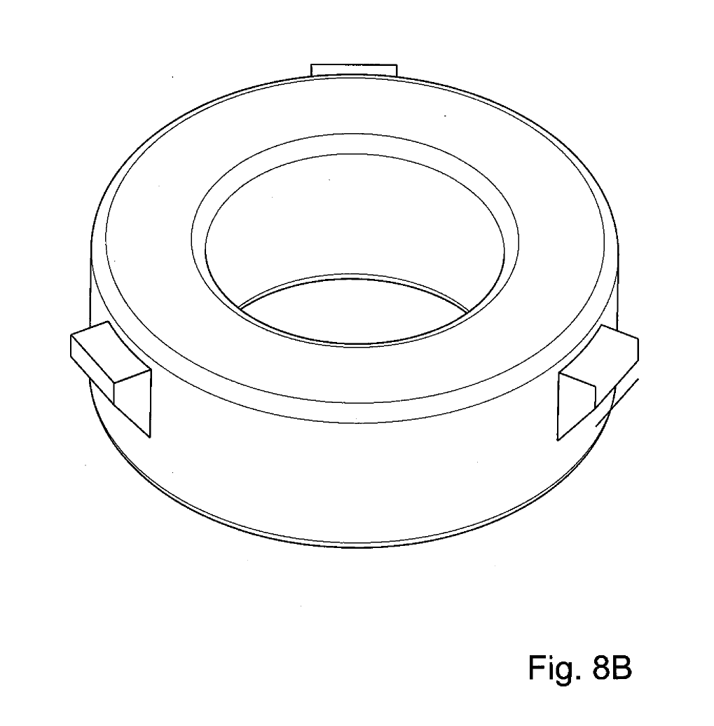

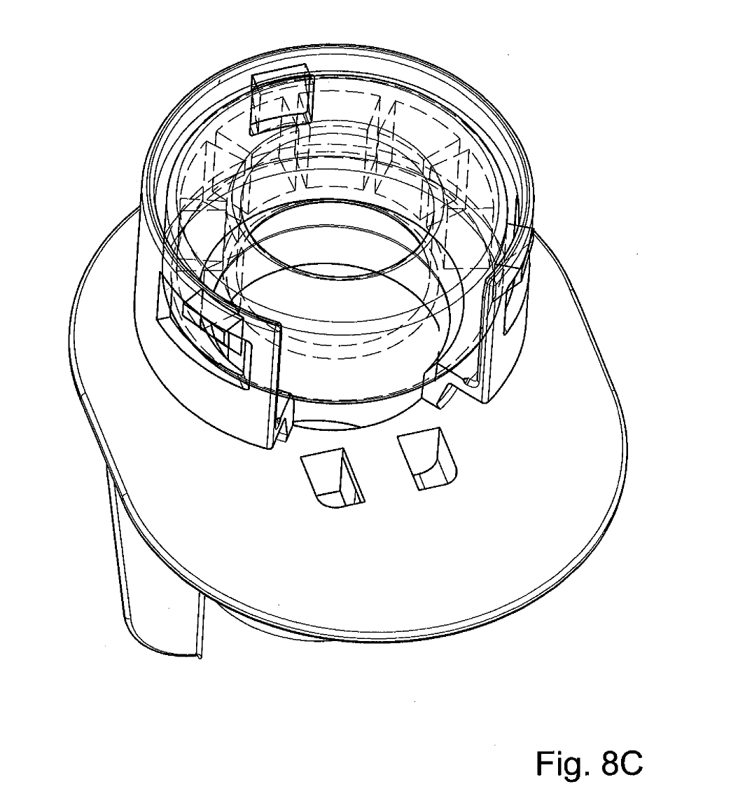

FIGS. 7 and 8 show a section of a plastic ring 223 according to the present invention, which is not closed, but rather only forms about an angle of 270° or less. FIG. 7A shows a section, such that the chambers 35, which are used for accommodating the single magnets 24 not shown, are readily visible. By reducing the number of chambers 35 and consequently also the number of permanent magnets 24 by approx. 25% compared to a closed plastic ring 223 with permanent magnetic elements distributed uniformly over the circumference in this exemplary embodiment, considerable costs are saved. The number of permanent magnets 24 results from the function desired by the client.

FIG. 7B shows an isometric view of the not closed plastic ring 223. This open plastic ring 223 is shown in FIG. 7C in the installed state. In this case, the plastic ring 223 is shown as “transparent,” such that all six permanent magnetic elements 24 are visible.

In FIG. 7C the open plastic ring 223 is accommodated in the neck 222. The neck 222 is designed, such that the plastic ring 223 is positioned correctly aligned over one or more coding elements, such as, for example, detents (not visible in FIG. 7C) in relation to the neck 222. Thereby, an erroneous installation is effectively prevented.

This exemplary embodiment is especially suitable if the gas hose nozzle or the fuel nozzle cannot be inserted in any random position or angle of rotation into the neck 222. This means namely that permanent magnetic elements 24 are not needed over the entire circumference of the neck.

FIG. 8C shows a section of another exemplary embodiment of a plastic ring 223, which is designed as closed, but in which chambers 35, which are used for accommodating permanent magnetic elements 24 not shown, are recessed only over an angle at circumference of somewhat more than 180°. Depending on the function, the magnets 24 may be arranged over an angle at circumference smaller than or equal to 360°.

FIG. 8B shows this closed plastic ring 223. Here, three detents 37 are also visible, which are used for coding or for correctly aligning the plastic ring in relation to the neck 23. It is recommended here to arrange the detents 37 not uniformly with an angle of 120°, but rather to provide unequal distances, so that the plastic ring 223 can be inserted only in the correct position and location into the neck 222.

In general, it can be said that the alignment of the magnets 24 in regard to the north and south poles can take place axially and radially.

While specific embodiments of the invention have been shown and described in detail to illustrate the application of the principles of the invention, it will be understood that the invention may be embodied otherwise without departing from such principles.

1-10. (canceled)

11. A device for preventing an incorrect filling of a tank of motor vehicles by means of a gas hose nozzle, the device being provided at one of a filler neck of the tank or at an insert for the filler neck or the filling opening of the tank and/or at the discharge pipe of the gas hose nozzle, the device comprising:
a permanent magnet array comprising:
a partial array in the form of a single magnet in the discharge pipe of the gas hose nozzle; and
another permanent magnet partial array comprising a plurality of permanent magnetic elements arranged in a ring-shape and spaced apart in the filler neck or in the insert or about the discharge pipe of the gas hose nozzle; and
a closed or open body, the permanent magnetic elements arranged in a ring-shape being held in the closed or open body, wherein the body has a closed or open ring-shaped design and north and south poles of the permanent magnetic elements are aligned in a radial direction or in a direction of a longitudinal axis of the filler neck.

12. A device in accordance with claim 11, wherein the permanent magnetic elements arranged in the filler neck or in the insert in the body have a plate-shaped or cube-shaped design lying in the circumferential direction or a rod-shaped design lying in the axial or radial direction.

13. A device in accordance with claim 11, wherein the permanent magnetic elements form an angle at a circumference of less than 330°.

14. A device in accordance with claim 11, wherein the permanent magnetic elements form an angle at a circumference of less than 300°.

15. A device in accordance with claim 11, wherein the permanent magnetic elements form an angle at a circumference of less than 270°.

16. A device in accordance with claim 11, wherein the body is made of plastic and the permanent magnetic elements are held in the body made of plastic.

17. A device for preventing an incorrect filling of a tank of motor vehicles, the device comprising:
a permanent magnet array comprising:
a magnet array portion comprising a single magnet in the discharge pipe of the gas hose nozzle; and
a permanent magnet partial array comprising a plurality of permanent magnetic elements; and
a ring or partial ring body, the permanent magnetic elements being arranged in the ring or partial ring body in a ring-shape and being spaced apart from each other in the filler neck or in the insert or about the discharge pipe of the gas hose nozzle, wherein the body has a closed ring shape or an open ring-shape and north and south poles of the permanent magnetic elements are aligned in a radial direction or in a direction of a longitudinal axis of the filler neck.

18. A device in accordance with claim 17, wherein the permanent magnetic elements, arranged in the filler neck or in the insert in the body, have a plate-shaped or cube-shaped design, lying in a circumferential direction or a rod-shaped design lying in an axial or radial direction.

19. A device in accordance with claim 17, wherein the permanent magnetic elements form an angle at a circumference of less than 330°.

20. A device in accordance with claim 17, wherein the permanent magnetic elements form an angle at a circumference of less than 300°.

21. A device in accordance with claim 17, wherein the permanent magnetic elements form an angle at a circumference of less than 270°.

22. A device in accordance with claim 17, wherein the body is made of plastic and the permanent magnetic elements are held in the body made of plastic.
